(19) United States
(12) Patent Application Publication
(10) Pub. No.: US 2026/0078259 A1
(43) Pub. Date: Mar. 19, 2026

(54) CALCIUM TITANATE PARTICLE MATERIAL, METHOD FOR PRODUCING SAME, SLURRY COMPOSITION, AND RESIN COMPOSITION

(71) Applicant: ADMATECHS CO., LTD., Miyoshi-shi (JP)

(72) Inventors: Kenta TAKEI, Miyoshi-shi (JP); Keisuke KURITA, Miyoshi-shi (JP); Yoshitaka SAITO, Miyoshi-shi (JP)

(73) Assignee: ADMATECHS CO., LTD., Miyoshi-shi (JP)

(21) Appl. No.: 19/400,239

(22) Filed: Nov. 25, 2025

Related U.S. Application Data
(63) Continuation of application No. PCT/JP2023/019961, filed on May 29, 2023.

(51) Int. Cl. C09C 1/36; C08K 9/02; C09C 3/06

(52) U.S. Cl. CPC C09C 1/36; C08K 9/02; C09C 3/063; C01P 2004/32; C01P 2004/64; C01P 2004/84; C01P 2006/12; C01P 2006/82

(57) ABSTRACT

An object to be achieved is to provide a calcium titanate particle material in which change in color due to radiation of ultraviolet rays is suppressed. A calcium titanate particle material of the present disclosure for achieving the above object has: a circularity of 0.8 or more; and a volume-average particle diameter and a specific surface area respectively represented by “a” (μm) and “b” (m²/g), the “a” being 0.1 or more and 8 or less, “ab” being less than 4. Since the calcium titanate particle material has this configuration, the relationship between the volume-average particle diameter and the specific surface area is made appropriate. As a result, the calcium titanate particle material allows suppression of change in color occurring over time.

### CROSS REFERENCE TO RELATED APPLICATIONS

The present application is a Continuation Application of International Application No. PCT/JP2023/019961, filed on May 29, 2023, which is incorporated herein by reference.

### TECHNICAL FIELD

The present disclosure relates to a calcium titanate particle material, a method for producing the same, a slurry composition, and a resin composition, and specifically relates to a calcium titanate particle material, a method for producing the same, and a slurry composition and a resin composition in which the calcium titanate particle material has been dispersed.

### BACKGROUND ART

In recent years, electronic devices have been increasingly configured to be driven at high speed and at high frequency. Thus, decrease of transmission loss in electronic device materials such as substrate materials and sealing materials has been an important issue. The magnitude of the transmission loss is significantly influenced by the dissipation factor (Df), and use of a material having a low Df leads to decrease in the transmission loss.

Electronic device materials are, in some uses thereof, required to be materials having high permittivities (Dk). However, materials having a high Dk often exhibit a high Df, and thus the Df is required to be lowered to decrease the transmission loss. A material that is highly likely to realize a high Dk and a low Df is calcium titanate (Patent Literature 1).

### CITATION LIST

### Patent Literature

Patent Literature 1: WO2022/124396

### SUMMARY OF INVENTION

### Technical Problem

Meanwhile, calcium titanate colors upon exposure to ultraviolet rays. Therefore, a problem arises in that the color of a resin composition obtained by dispersing a particle material formed from calcium titanate in a resin material changes over time, and the appearance of the resin composition changes over time.

The present disclosure has been made in view of the above circumstances, and an object of the present disclosure is to provide a calcium titanate particle material in which change in color due to radiation of ultraviolet rays is suppressed, a method for producing the same, a slurry composition, and a resin composition.

### Solution to Problem

A calcium titanate particle material of the present disclosure for achieving the above object has:
a circularity of 0.8 or more; and
a volume-average particle diameter and a specific surface area respectively represented by “a” (μm) and “b” (m²/g), the “a” being 0.1 or more and 8 or less, “ab” being less than 4.

A method for producing the calcium titanate particle material of the present disclosure for achieving the above object includes a spherical-shape-obtaining step of supplying a raw particle material containing calcium titanate as a main component into a high-temperature atmosphere in a state where the raw particle material is dispersed in a carrier.

A slurry composition of the present disclosure for achieving the above object includes: the calcium titanate particle material of the present disclosure; and a dispersion medium as a liquid substance in which the calcium titanate particle material has been dispersed.

A resin composition of the present disclosure for achieving the above object includes: the calcium titanate particle material of the present disclosure; and a resin material in which the calcium titanate particle material has been dispersed.

### Advantageous Effects of Invention

Since the calcium titanate particle material of the present disclosure has the above configuration, the relationship between the volume-average particle diameter and the specific surface area is made appropriate. As a result, the calcium titanate particle material allows suppression of change in color occurring over time.

### DESCRIPTION OF EMBODIMENTS

Hereinafter, a calcium titanate particle material according to an embodiment of the present disclosure will be described in detail. The calcium titanate particle material according to the present embodiment is suitably usable as an electronic device material. Specific examples of an electronic device to which the calcium titanate particle material is preferably applied include antenna-in-packages, and the calcium titanate particle material is preferably applied as a slurry composition or a resin composition. The resin composition is applied to, for example, a prepreg, a copper-clad laminate, or a film. A numerical range written as “a” to “b” in the present description includes the values “a” and “b”. A range including neither “a” nor “b” may be defined through amendment. Furthermore, in a case where numerical values are written in the present description, a numerical range for which values arbitrarily selected from the numerical values are combined and set as an upper limit and a lower limit of the numerical range is usable. Also, values arbitrarily selected from the numerical values may be set as an upper limit and a lower limit. These values used as the upper limit and the lower limit may be or do not have to be included in a set range. Furthermore, one value out of the upper limit and the lower limit may be included in the range, and the other value may be excluded from the range.

### (Calcium Titanate Particle Material)

The calcium titanate particle material according to the present embodiment contains calcium titanate as a main component. The phrase “contains calcium titanate as a main component” means that: the lower limit value of the amount of the calcium titanate is 50% by mass; and the lower limit value is preferably 60% by mass, 70% by mass, 80% by mass, 90% by mass, 95% by mass, 99% by mass, or 100% by mass (unavoidable impurities or a trace amount of impurities may be contained). Compounds that may be contained other than calcium titanate are iron oxide, molybdenum oxide, and silicon dioxide. The impurities may be contained in a crystal of the calcium titanate or may be contained as independent particles.

Silicon dioxide further suppresses coloring, and thus is particularly preferably contained. Examples of the upper limit value of the silicon dioxide content include 10% by mass, 7.5% by mass, and 5.0% by mass. Examples of the lower limit value of the silicon dioxide content include 1.0% by mass, 2.0% by mass, and 3.0% by mass. These upper and lower limit values may be arbitrarily combined. Setting the silicon dioxide content to be this lower limit value or more leads to sufficient suppression of coloring. Meanwhile, setting the silicon dioxide content to be this upper limit value or less leads to a high permittivity or otherwise leads to improvement of dielectric characteristics.

The silicon dioxide content may be set to fall within the above range with the mass of the entire calcium titanate particle material being regarded as a reference, and in particular, the amount of the silicon dioxide on the surface of the calcium titanate particle material is preferably within the range between these upper and lower limit values.

In particular, presence of silica on the surface leads to decrease in an amount by which ultraviolet rays reach the calcium titanate. Specifically, a silicon dioxide content measured through energy-dispersive X-ray spectroscopy (EDX) further preferably falls within the range between the above upper and lower limit values. The EDX is, in particular, a measurement method in which a measurement value is dependent on an atomic composition on the surface.

The calcium titanate particle material according to the present embodiment has a circularity of 0.8 or more, preferably 0.85 or more, more preferably 0.9 or more, further preferably 0.95 or more, and particularly preferably 0.99 or more.

In measurement of the circularity, a photograph is taken with an SEM, and, from an area and a perimeter of each of particles observed in the photograph, a value is calculated as a circularity according to (circularity)={4π×(area)÷(perimeter)²}. A circularity more approximate to 1 indicates that the shape of the particle is more similar to the shape of a perfect sphere. Specifically, an average value obtained through measurement of 100 particles by using an image processing device (Sysmex Corporation: FPIA-3000) is used.

The calcium titanate particle material according to the present embodiment has a volume-average particle diameter and a specific surface area respectively represented by “a” (μm) and “b” (m 2/g). The “a” is 0.1 or more and 8 or less. The lower limit value of the “a” is more preferably 0.2 or 0.3, and the “a” is preferably 7.0, 6.0, 5.5, 5.0, 4.0, or 2.5. When the “a” is not less than the lower limit value, the dispersibility in a slurry composition such as a varnish is improved. Meanwhile, when the “a” is not more than the upper limit value, the sedimentation speed decreases, whereby separation becomes less likely to occur.

The upper limit value of the “b” is preferably 2.2, 2.0, 1.8, or 1.5, and the lower limit value of the “b” is preferably 0.1, 0.2, or 0.4. “ab” is less than 4. The upper limit value of the “ab” is preferably 4.0, 3.5, 3.0, 2.5, or 2.0. These upper and lower limit values of each of the “a”, “b”, and “ab” may be arbitrarily combined.

The calcium titanate particle material according to the present embodiment has a water content of preferably 800 ppm or less. The upper limit value of the water content is further preferably 700 ppm, 600 ppm, 500 ppm, 400 ppm, or 300 ppm. The water content is measured through the Karl Fischer method. By decreasing the water content, a Df value is decreased, and a side reaction at the time of dispersion in a resin is suppressed.

The calcium titanate particle material according to the present embodiment has a Df of preferably 0.016 or less, more preferably 0.015 or less, further preferably 0.010 or less, and particularly preferably 0.008 or less.

The calcium titanate particle material according to the present embodiment has b*/a* of preferably 5 or more, more preferably 5.5 or more, and further preferably 6.0 or more. The b*/a* is measured as follows. That is, a color difference meter (e.g., spectral colorimeter CM-5 manufactured by Konica Minolta, Inc.) is used to perform measurement on a liquid dispersion obtained by dispersing a sample of the calcium titanate particle material in a cyclohexane solution at a concentration of 33.3% by mass, the sample having a surface leveled to have a thickness of 5 mm or less, the surface having been irradiated by using a mercury lamp at a light intensity of 11.5 KW/m² for 72 hours.

The calcium titanate particle material according to the present embodiment is preferably subjected to surface treatment. A surface treatment agent is not particularly limited, and a silane compound such as a silane coupling agent or a silazane compound is preferably used. Examples of the silane compound include silane compounds having organic functional groups such as an alkyl group, a phenyl group, an amino group, a phenylamino group, a vinyl group, a methacrylic group, and an epoxy group, singly or in combination. Examples of the silazane compound include hexamethyldisilazane.

As the surface treatment agent, a single compound is usable, or a plurality of compounds may be mixed and used. The organic functional groups are determined according to the type of a resin material or a dispersion medium to be combined. The amount of the surface treatment agent for performing the surface treatment is not particularly limited, and the surface treatment may be performed with the amount being 0.1 to 5.0 parts by mass per 100 parts by mass of the calcium titanate particle material.

### (Method for Producing Calcium Titanate Particle Material)

A method for producing the calcium titanate particle material according to the present embodiment is a method for suitably producing the above calcium titanate particle material according to the present embodiment and includes a spherical-shape-obtaining step and other steps selected as necessary.

The spherical-shape-obtaining step is a step of heating and melting a raw particle material in a high-temperature atmosphere to form the raw particle material into a spherical shape, and then rapidly cooling the raw particle material to obtain a particle material having a high circularity. The high-temperature atmosphere is not particularly limited but is at a temperature of not less than a temperature at which calcium titanate is softened or melted.

For the high-temperature atmosphere, for example, plasma or flame formed by combusting a mixture obtained by mixing a combustible gas with a combustion aid gas is usable. Examples of the combustible gas include propane gas, acetylene gas, and hydrogen gas.

The raw particle material is controlled according to the tendencies of the volume-average particle diameter and the particle size distribution of the raw particle material in terms of the volume-average particle diameter and the particle size distribution of the calcium titanate particle material to be obtained after the spherical-shape-obtaining step.

The raw particle material is caused to have a necessary particle size distribution by: making coarse particles thereof finer through a pulverization operation; at the time of synthesis of calcium titanate, forming the calcium titanate into particles; melting calcium titanate and forming the calcium titanate into particles by using an atomizer; or another method.

The raw particle material is supplied into the high-temperature atmosphere in a state of a dispersion obtained by dispersing the raw particle material in a carrier. As the carrier, a gas exemplified by an inert gas such as nitrogen gas, a combustion aid gas such as oxygen gas, and a combustible gas such as propane gas, or a liquid exemplified by water, an alcohol such as methanol or isopropanol, or a ketone such as acetone, is usable.

The raw particle material is a particle material containing calcium titanate as a main component, and the composition of the raw particle material is as described above in relation to the composition of the calcium titanate that is produced. Thus, further description of the composition will be omitted. Here, the composition of the raw particle material is substantially directly reflected in the composition of the calcium titanate particle material having been produced. Therefore, for example, the composition and the purity of the raw particle material are set according to the composition and the purity of the calcium titanate particle material to be eventually produced.

As described above, in the case of increasing only the silicon dioxide content on the surface of the calcium titanate particle material, the increase is realized by causing a particle material (silica particle material) formed from silicon dioxide to enter a state of being adhered on the surface of the raw particle material. A silica particle material having a smaller particle diameter than the raw particle material easily coats the surface of the raw particle material, and thus is preferable. For example, the particle diameter of the silica particle material is set to about 1 to 100 nm. Such a silica particle material may be subjected to surface treatment with a silane compound or a silazane compound to introduce, for example, a phenyl group or an alkyl group such as a methyl group.

The silica particle material may be mixed in a dried state or may be mixed in a wet state. An operation for the mixing may involve: performing stirring and mixing by using a mixer; performing a pulverization operation by using a pulverizer such as a vibration mill to achieve the mixing; or, in the case of mixing in a wet state, applying vibration through insonation or the like to achieve the mixing.

In the case of mixing in a wet state, a slurry obtained by dispersing the raw particle material and the silica particle material in a carrier in liquid form may be supplied into the high-temperature atmosphere.

The concentration of the raw particle material dispersed in the carrier and the supply speed of the dispersion are not particularly limited, and about 0.5 kg to 10 kg of the raw particle material may be provided per 1 Nm³ of the carrier in gas form. The lower limit value of the amount of the raw particle material may be set to 1 kg or 2 kg, and the upper limit value of the amount of the raw particle material may be set to 10 kg, 8 kg, or 3 kg.

The supply speed of the dispersion may be set to about 5 kg of the raw particle material per hour to 15 kg of the raw particle material per hour depending on the size of the flame. The upper limit value of the supply speed may be set to about 15 kg/hour, 13 kg/hour, or 10 kg/hour, and the lower limit value of the supply speed may be set to about 5 kg/hour, 7 kg/hour, or 9 kg/hour.

The raw particle material may be subjected to the surface treatment that may be performed on the above calcium titanate particle material according to the present embodiment. The surface treatment leads to advantages such as improvement of fluidity.

### (Slurry Composition)

A slurry composition according to the present embodiment is obtained by mixing the calcium titanate particle material according to the present embodiment and a dispersion medium in liquid form to disperse the calcium titanate particle material in the dispersion medium. The mixing ratio of the calcium titanate particle material to the dispersion medium is not particularly limited, but the calcium titanate particle material content with the mass of the entirety being regarded as a reference is preferably 30% or more, more preferably 50% or more, and further preferably 70% or more.

As the dispersion medium, a liquid that is a so-called solvent such as an alcohol such as methanol or isopropanol, an alkane such as hexane, or a ketone such as acetone is usable. Alternatively, a liquid resin material precursor that is exemplified by a monomer and that is to be cured and unliquefied afterward is also usable. Whether the dispersion medium is in liquid form or not is determined according to whether the dispersion medium is in liquid form when being used under a specific condition that is arbitrarily set. Therefore, in the case of using a material at a high temperature or a low temperature, when the material takes a liquid form at the temperature, the material may be regarded as a dispersion medium. A compound to be dissolved in the dispersion medium may be dissolved in the dispersion medium.

The slurry composition according to the present embodiment may contain a particle material other than the calcium titanate particle material. For example, a particle material formed from an inorganic material such as silica or alumina, or a particle material formed from a resin material such as a polyolefin or a perfluoro polyolefin, may be contained.

### (Resin Composition)

A resin composition according to the present embodiment is obtained by mixing the calcium titanate particle material according to the present embodiment and a resin material to disperse the calcium titanate particle material in the resin material. The mixing ratio of the calcium titanate particle material to the resin material is not particularly limited, but the calcium titanate particle material content with the mass of the entirety being regarded as a reference is preferably 80% or more, more preferably 70% or more, and further preferably 60% or more.

Examples of the resin material include: pre-curing precursors of thermosetting resins such as epoxy resins and urea resins; thermoplastic resins such as polyolefins and polyesters; and monomers thereof. When the resin material is in liquid form, this resin composition may correspond not only to the resin composition according to the present embodiment but also to the slurry composition according to the present embodiment.

The resin composition according to the present embodiment may contain a particle material other than the calcium titanate particle material. For example, a particle material formed from an inorganic material such as silica or alumina, or a particle material formed from a resin material such as a polyolefin or a perfluoro polyolefin, may be contained.

### EXAMPLES

The calcium titanate particle material and the method for producing the same of the present disclosure will be described based on Examples.

### Test Example 1

A mixture of calcium titanate particles and spherical silica, which were pulverized through a pulverization operation, was used as a raw particle material. The spherical silica content with the mass of the entire raw particle material being regarded as a reference was set to 5.0%. The spherical silica had a particle diameter of 10 nm, and the raw particle material as the mixture of the calcium titanate particles and the spherical silica was in a state where the spherical silica was adhered on the surfaces of the calcium titanate particles.

10 kg/hour of the raw particle material was, in a state of being dispersed in 5 Nm³/hour of a carrier formed from nitrogen gas, supplied into flame formed in a furnace body (spherical-shape-obtaining step). The flame was formed by using 5 Nm³/hour of propane gas as a combustible gas and 17 Nm³/hour of oxygen as a combustion aid gas.

The raw particle material supplied into the flame was melted and formed into a spherical shape owing to surface tension. Then, the raw particle material came out of the flame to drop and was cooled to be solidified with the spherical shape being retained. The obtained spherical calcium titanate (calcium titanate particle material) was collected by using a bag filter, a cyclone, or the like and was used as a test sample in the present Test Example.

### Test Examples 2 and 3

Raw particle materials among which the particle diameters of calcium titanate particles differed were subjected to the spherical-shape-obtaining step under the conditions indicated in relation to Test Example 1, whereby test samples in the present respective Test Examples were prepared. As the particle diameter of the calcium titanate particles became smaller, the particle diameter of the obtained test sample also became smaller.

### Test Examples 4 and 5

The test samples in Test Examples 1 and 2 were subjected to surface treatment, whereby test samples in the present respective Test Examples were obtained. The surface treatment was performed by using KBM-1003 as a surface treatment agent.

### Test Example 6

The raw particle material used for preparation in Test Example 1 was directly used as a test sample in the present Test Example.

### Test Example 7

A particle material was obtained in the same manner as in Test Example 1 except that a raw particle material containing no spherical silica and containing only the calcium titanate particles was used. This particle material was used as a test sample in the present comparative example.

### (Evaluation)

For each of the test samples in the respective Test Examples, a circularity, colors a* and b*, a volume-average particle diameter, a specific surface area, a water content, a Df, and a silicon dioxide concentration (SiO₂ proportion: % by mass) were measured. These measurement values, the value of b*/a*, and the value of volume-average particle diameter×specific surface area are indicated in Table 1.

The circularity, the colors, and the water content were measured according to the corresponding methods described in the embodiment. The volume-average particle diameter was measured by using a laser-diffraction-type particle size distribution measurement device. The specific surface area was obtained by: weighing out 1.0 g of each of the test samples; supplying the test sample to a measurement cell; performing pretreatment; and then measuring the value of a BET specific surface area. As measurement machine, “Macsorb HM model-1208” (manufactured by Mountech Co., Ltd.) was used. The pretreatment was performed under conditions of a deaeration temperature of 200° C., a deaeration time of 30 minutes, and a cooling time of 4 minutes.

The Df was measured according to JIS C 2138 (2007). Specifically, a relative permittivity and a dissipation factor at 1 GHz were measured through a cavity resonator perturbation method by using a network analyzer (product name “E5071C”) manufactured by Keysight Technologies, Inc. Furthermore, the concentration of the silicon dioxide (proportion of SiO₂: % by mass) on the surfaces was measured through EDX. A content on a mass basis was calculated based on the obtained measurement value.

TABLE 1

| | Test | Test | Test | Test |
|---|---|---|---|---|
| | Example 1 | Example 2 | Example 3 | Example 4 |
| Shape | Spherical | Spherical | Spherical | Spherical |
| | shape | shape | shape | shape |
| Circularity | 0.95 | 0.91 | 0.94 | 0.92 |
| Color a* | 2 | 3 | 4 | 2 |
| Color b* | 13 | 17 | 20 | 13 |
| b*/a* | 6 | 5 | 5 | 7 |
| Particle | 5.2 | 1.2 | 0.5 | 5.2 |
| diameter | | | | |
| (μm) | | | | |
| Specific | 0.4 | 0.9 | 2.1 | 0.4 |
| surface area | | | | |
| (m²/g) | | | | |
| Particle | 1.9 | 1.0 | 1.0 | 1.9 |
| diameter × | | | | |
| specific | | | | |
| surface area | | | | |
| Water | 226 | 241 | 345 | 145 |
| content | | | | |
| (ppm) | | | | |
| Df | 0.005 | 0.007 | 0.016 | 0.003 |
| Proportion | 5.1 | 4.8 | 5.1 | 5.0 |
| of SiO₂ (% | | | | |
| by mass) | | | | |

| | Test | Test | Test |
|---|---|---|---|
| | Example 5 | Example 6 | Example 7 |
| Shape | Spherical | Pulverized | Spherical |
| | shape | | shape |
| Circularity | 0.94 | 0.75 | 0.94 |
| Color a* | 3 | 3 | 2 |
| Color b* | 19 | 8 | 7 |
| b*/a* | 7 | 3 | 4 |
| Particle | 1.2 | 2.3 | 5.1 |
| diameter | | | |
| (μm) | | | |
| Specific | 0.9 | 2.0 | 0.4 |
| surface area | | | |
| (m²/g) | | | |
| Particle | 1.0 | 4.6 | 2.0 |
| diameter × | | | |
| specific | | | |
| surface area | | | |
| Water | 48 | 915 | 245 |
| content | | | |
| (ppm) | | | |
| Df | 0.005 | 0.017 | 0.006 |
| Proportion | 4.9 | Detection | Detection |
| of SiO₂ (% | | limit | limit |
| by mass) | | | |

As is obvious from Table 1, the test samples in Test Examples 1 to 5 were found to have larger b*/a* values and were found to allow further suppression of change in color, than the test sample in Test Example 6. In addition, the test samples in Test Examples 1 to 5 had lower water contents and smaller Df values than the test sample in Test Example 6. The test samples in Test Examples 1 to 5 had more silicon dioxide than the test sample in Test Example 6.

In Test Examples 4 and 5 in which surface treatment was performed, the b*/a* values were slightly larger than in Test Examples 1 to 3 identical to Test Examples 4 and 5 except that surface treatment was not performed. These results provide a finding that surface treatment allows suppression of change in color. Furthermore, in Test Examples 4 and 5 in which surface treatment was performed, the water contents were low and the Df values were small. Also, the test sample in Test Example 1 containing silica was found to have a larger b*/a* value and was found to have sustained less change in color, than the test sample in Test Example 7 containing no silica.

1. A calcium titanate particle material having:
a circularity of 0.8 or more;
a volume-average particle diameter and a specific surface area respectively represented by “a” (μm) and “b” (m²/g), the “a” being 0.1 or more and 8 or less, “ab” being less than 4;
a silicon dioxide content of 2 to 10% by mass, the silicon dioxide content having been measured through energy-dispersive X-ray spectroscopy; and
b*/a* of 5 or more, the b*/a* having been measured through a measurement method in which a color difference meter is used to perform measurement on a liquid dispersion obtained by dispersing a sample of the calcium titanate particle material in a cyclohexane solution at a concentration of 33.3% by mass, the sample having a surface leveled to have a thickness of 5 mm or less, the surface having been irradiated by using a mercury lamp at 11.5 KW/m² for 72 hours.

2. The calcium titanate particle material according to claim 1 having a water content of 800 ppm or less.

3. The calcium titanate particle material according to claim 1 having a dissipation factor of 0.016 or less.

4. The calcium titanate particle material according to claim 1 having been subjected to surface treatment.

5. A method for producing the calcium titanate particle material according to claim 1, the method comprising
a spherical-shape-obtaining step of supplying a raw particle material containing calcium titanate as a main component into a high-temperature atmosphere in a state where the raw particle material is dispersed in a carrier, the raw particle material having a surface on which a silica particle material formed from silica having a particle diameter of 1 to 100 nm has been adhered.

6. A method for producing the calcium titanate particle material according to claim 2, the method comprising
a spherical-shape-obtaining step of supplying a raw particle material containing calcium titanate as a main component into a high-temperature atmosphere in a state where the raw particle material is dispersed in a carrier, the raw particle material having a surface on which a silica particle material formed from silica having a particle diameter of 1 to 100 nm has been adhered.

7. A method for producing the calcium titanate particle material according to claim 3, the method comprising
a spherical-shape-obtaining step of supplying a raw particle material containing calcium titanate as a main component into a high-temperature atmosphere in a state where the raw particle material is dispersed in a carrier, the raw particle material having a surface on which a silica particle material formed from silica having a particle diameter of 1 to 100 nm has been adhered.

8. A method for producing the calcium titanate particle material according to claim 4, the method comprising
a spherical-shape-obtaining step of supplying a raw particle material containing calcium titanate as a main component into a high-temperature atmosphere in a state where the raw particle material is dispersed in a carrier, the raw particle material having a surface on which a silica particle material formed from silica having a particle diameter of 1 to 100 nm has been adhered.

9. A slurry composition comprising:
the calcium titanate particle material according to claim 1; and
a dispersion medium as a liquid substance in which the calcium titanate particle material has been dispersed.

10. A slurry composition comprising:
the calcium titanate particle material according to claim 2; and
a dispersion medium as a liquid substance in which the calcium titanate particle material has been dispersed.

11. A slurry composition comprising:
the calcium titanate particle material according to claim 3; and
a dispersion medium as a liquid substance in which the calcium titanate particle material has been dispersed.

12. A slurry composition comprising:
the calcium titanate particle material according to claim 4; and
a dispersion medium as a liquid substance in which the calcium titanate particle material has been dispersed.

13. A resin composition comprising:
the calcium titanate particle material according to claim 1; and
a resin material in which the calcium titanate particle material has been dispersed.

14. A resin composition comprising:
the calcium titanate particle material according to claim 2; and
a resin material in which the calcium titanate particle material has been dispersed.

15. A resin composition comprising:
the calcium titanate particle material according to claim 3; and
a resin material in which the calcium titanate particle material has been dispersed.

16. A resin composition comprising:
the calcium titanate particle material according to claim 4; and
a resin material in which the calcium titanate particle material has been dispersed.
